(19) United States
(12) Patent Application Publication
(10) Pub. No.: US 2007/0008167 A1
(43) Pub. Date: Jan. 11, 2007

(54) Lighting system

(76) Inventors: Richard Parker JR., Lutz, FL (US); Robert Fugerer, Lutz, FL (US)

Correspondence Address: GIFFORD, KRASS, GROH, SPRINKLE & CITKOWSKI, P.C, PO BOX 7021, TROY, MI, 48007-7021, US

(21) Appl. No.: 11/481,135

(22) Filed: Jul. 5, 2006

Related U.S. Application Data
(60) Provisional application No. 60/696,630, filed on Jul. 5, 2005.

(51) Int. Cl. G09F 9/33

(52) U.S. Cl. 340/815.45

(57) ABSTRACT

A lighting source and lighting control assembly, and fixture therefor, the combination of which allows its user to comply with pertinent laws while maximizing the ability to obtain a determined amount and type of lighting when so desired.

### RELATED APPLICATION

This application claims priority of U.S. Provisional Patent Application Ser. No. 60/696,630 filed Jul. 5, 2005, which is incorporated herein by reference.

### BACKGROUND OF THE INVENTION

A. Field of the Invention

This invention relates to lighting systems and devices, and, as later discussed, more particularly to a solid-state lighting system, through use of light emitting diodes (LEDs), and which comprises a device having an internal power converter, as well as an internal controller for enabling various lighting operations and/or effects.

B. Description of the Related Art

Sources of lighting now in use by coastal communities in the United States and around the world for illuminating beachfront residences and developments are varied. Some of these sources comprise types of illumination including incandescent filtered lighting, high-pressure sodium lighting, and low-pressure sodium lighting. These same exemplary lighting sources are also in use in other settings such as wildlife habitats, including, for example, parks and observatories.

However, a particular ability to use a certain lighting source is often curtailed by laws being placed into effect, or already in effect, which seek to address the effect of various lighting sources on wildlife habitation along coastal boundaries and in or around the habitats mentioned above. Specifically, a concern exists that lighting sources being used in these environments emit a wavelength of light, which endangers the very existence of various wildlife. A known example of this concern exists in regard to the habitation, nesting and other activity of sea turtles and their hatchlings along coastlines throughout the world. Accordingly, because of these laws, homeowners and management of wildlife habitats are commonly left with little option as to the optimal lighting source they may use, when they may use it, and the expense they must incur in the use of a particular lighting source in attempting to obtain full compliance with those laws.

In addition to regulatory demands, users of these lighting sources also face functional restraints related directly to the particular type of lighting which is desired and which, invariably, adds to the expense of maintaining properly authorized lighting. A first of these restraints includes a diminished long-term lighting capacity resulting from, for example in the case of incandescent light, the failure thereof caused by the overheating of high wattage bulbs. A second restraint relates to a need to often use separate components, including, for example, power converters and controllers, which need to be located and maintained apart from the lighting fixture containing the lighting source. Still further, a third restraint has been observed insofar as the limited options that exist in regard to various functions able to be performed by any one lighting source that would otherwise address the first and second restraints as mentioned.

With each of the exemplary lighting sources discussed above, an inability to obtain proper amounts of lighting has also been observed insofar as an ability to obtain a variably scheduled yielding of an amount of lighting desirable for addressing the various needs of lighting users. This often occurs as a result of, for example, functional limitations of the lighting fixture and associated control apparatus, the burning out of bulbs, and poor light emission.

Thus, it would be beneficial to provide a lighting source and lighting control assembly, and fixture therefor, the combination of which allows its user to comply with pertinent laws while maximizing the ability to obtain a determined amount and type of lighting when so desired.

### SUMMARY OF THE INVENTION

Accordingly, it is contemplated to provide a lighting source and fixture therefor, in which the lighting source is housed within the fixture, and in which the operation of the lighting source is variously controllable relative to parameters comprising, optionally, energy, time, motion, and communicability.

### BRIEF DESCRIPTION OF THE DRAWINGS

FIG. 1 is an exploded perspective view of one preferred lighting fixture of the present invention;

FIG. 2 is an elevational view, partially in cross section, of another preferred lighting fixture of the present invention; and

FIG. 3 is a schematic illustration of a lighting system of the present invention.

### DETAILED DESCRIPTION OF THE PREFERRED EMBODIMENT

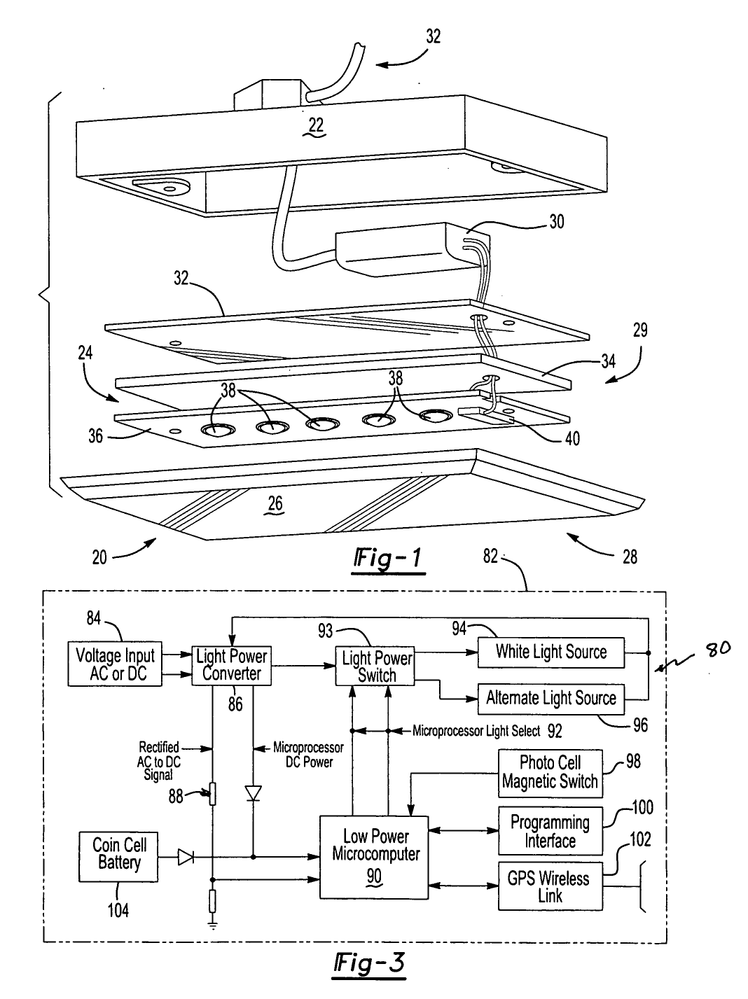

With reference to FIG. 1, there is contemplated a ceiling or wall mounted lighting fixture 20. The fixture 20 comprises a mounting unit, such as a partial housing 22, for containing a lighting source and lighting control assembly 24 therein, and to which a prismatic lens 26 attaches at the top 28 thereof for dispersion of light. The housing 22 comprises a lighting control assembly 29 internal thereto. The assembly 29 comprises an integrated power converter 30 for transforming an incoming voltage source 32 from, optionally, an alternate current (AC) to a direct current (DC), or alternately, for otherwise manipulating an incoming DC to that which may be used by the fixture 20. The converter 30 is held within the housing 22 by means commonly known. The assembly 29 comprises a reflector 32, a heat dissipating aluminum substrate 34, a printed circuit board 36 onto which there is mounted a plurality of light emitting diodes (LEDs) 38, and, optionally, a microcontroller 40 for coordinating varied functions as later discussed.

In operation, the lens 26 and reflector 32 cooperate to enable a desired dispersion of light from the fixture 20, while the substrate 34 acts as a heat sink to minimize the effect of heat which may be generated by any one of the components previously discussed.

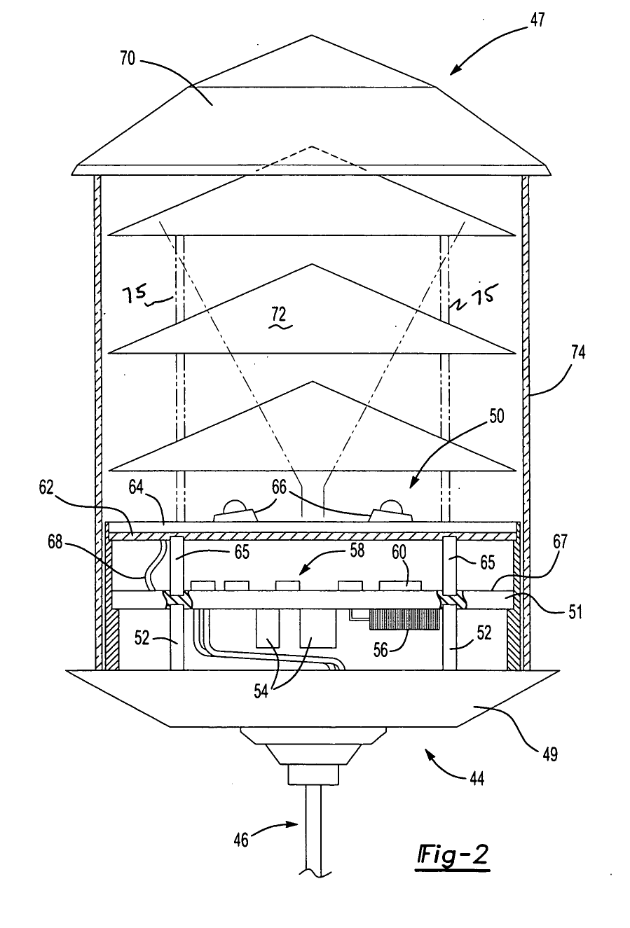

Referring to FIG. 2, a contemplated design for a low profile pagoda pathway lighting fixture 47 is shown whereby, as the name suggests and as FIG. 2 illustrates, light is dispersed in a downwardly and tiered manner. The fixture 47 is intended for use along garden pathways and the like. The fixture 47 comprises a mounting unit 44 for attachment with the ground and through which a voltage source 46 is routed. A flared base 49 sits atop the mounting unit 44 for supporting a lighting source 50 and a lighting control assembly 48 internal to the fixture 47.

As illustrated in FIG. 2, the lighting control assembly 48 comprises a double-sided printed circuit board 51 supported above the base 49 upon mounts 52 and to which a variety of electrical components, including capacitors 54, at least one inductor 56, color signaling transmitters 58 and a microprocessor 60 are attached. Separated and supported upon the circuit board 51 is an aluminum substrate 62 mounted, for example, by an adhesive such as epoxy, with a printed circuit board 64 containing a plurality of LEDs 66. The substrate 62 is further mounted with the printed circuit board 64 by spacers 65 received in openings 67 thereon.

In operation, the LEDs 66 are energized by a power feed 68 running between the circuit boards 51 and 64. Light is emitted from the fixture 47 upon operation of the LEDs 66, and dispersed upon capturing thereof by a downwardly shade 70 after such dispersion is intercepted and transmitted from reflectors 72 and filtered through an acrylic lens 74. Each of the reflectors 72 are connected by a series of rods 75.

With reference to FIG. 3, there is provided a diagram of a contemplated assembly illustrating the operation of a system of components usable as a lighting control system 80, for use with either of the light fixtures discussed herein, for directing and coordinating a variety of lighting functions and/or effects.

As shown in FIG. 3 the lighting control system 80, as presently contemplated, is illustrated. As will be understood by reference thereto and in consideration of discussion thus far, it is to be recognized that all of the lighting control components are housed within and/or by a lighting fixture 82. As illustrated, the lighting control system 80.accepts a voltage input 84 from, most commonly, an electrical main such as an outlet (not shown). This input 84, as received in the form of an alternate current (AC), is transformable into a direct current (DC) through use of a power converter 86 and necessary rectification circuitry 88, the design of which is illustrated in FIG. 4. This rectified signal is then directed to a low power microcomputer 90 which provides various commands to produce various lighting functions and effects. Among these commands, as further shown in FIG. 5, is signaling, through use of a microprocessor 92, to a switch 93 to selectively cause emission of a white or alternate; and optionally red, LED light source 94 or 96 from the light fixture 82.

Additionally, as may be understood from FIG. 3 the microcomputer 90 may, optionally, also command communication by an interface with a photocell magnetic switch 98 to allow operation by motion detection, with a programmable interface 100 to determine various lighting timing functions and effects, and with a global positioning satellite (GPS)/wireless link 102 to coordinate all lighting functions, operations and effects among several lighting fixtures operatively connected together to produce a network of similarly lit lighting fixtures.

As also shown in FIG. 3, the contemplated design of the lighting control system 80 comprises an alternate power source for the low power microcomputer 90, optionally in the form of a coin cell battery 104, to insure against the loss of power thereby upon receipt of the rectified signal. It is to be understood that the power fed to the low power microcomputer 90 may be that which is in the form of AC or DC power, and that the power converter 86 is, optionally, suited to convert DC power to a further DC power in situations in which such conversion is necessary and/or desirable.

It is to be understood that the wavelength of light to be emitted by any one of the light fixtures discussed is approximately 650 nm red and, optionally, a lesser or greater variance therefrom as may be appropriate and/or desirable when use in any one application is contemplated. For lighting where the effect on wildlife is concerned such as in use around beaches where sea turtles nest it has been found that wavelengths of 580-650 nm are preferred. Wavelengths in this range have been found to have the least effect in disorientating sea turtle hatchlings in their attempt to move from the nest to the water.

In regard to the groupings of LEDs contemplated, it is to be understood that such LEDs may be grouped in a manner so as to provide, for example, a first white LED and then a second alternately colored LED so as to provide the desired operation and effect. Further, it is to be understood that the sizing of all necessary circuitry components is contemplated as necessary and desirable, according to knowledge well understood by one of ordinary skill in the art, so as to insure against unintended damage to any one electrical component and to maximize intended illumination from any one light fixture. In obtaining or providing lighting of a desired wavelength, it is to be understood that the use of dichroic filtering of incandescent or fluorescent lighting may also be employed for use with any of the lighting fixtures discussed herein.

Additionally, it is to be understood that, in regard to the circuitry comprising the lighting control system 80, various componentry is contemplated. For example, at the option of the user, it may be contemplated that light emitting capacitors and solid-state lighting in the form of organic LEDs may be used. In further regard to use of LEDs, it is to be understood that LEDs of the type manufactured as LUMILEDS LUXEON LEDs, as of at least the date of filing of the description herein, are, optionally, contemplated for use as an exemplary type of LED with the lighting fixtures described herein. While these are more examples of components which are contemplated for use with the subject matter discussed herein, it will be understood by one of ordinary skill in the art that other variants of such components, and others, may be used in achieving the assembly described herein; also, that such components discussed as being included as those comprising the lighting control assemblies mentioned are intended to operate in cooperation to produce a certain lighting operation and/or effect. Further, it is to be understood that the maximum electro-luminescence, with or without filtering, is contemplated so as to maximize spectral output.

The lighting system as described above is believed to meet all turtle friendly and wildlife friendly state, county and local ordinance standards.

Ordinary incandescent lighting produces carbon dioxide emissions and the bulbs present serious disposal problems because they contain chemicals such as lead, mercury and arsenic. LEDs do not radiate any emissions and contain no mercury or lead.

Further 83% of the electricity used to light a 100 watt incandescent bulb produces IR output not visible to humans. LEDs produce up to 40-50 Im/W at 12 v, compared to 8-15 Im/W at 110-120 v of incandescent bulbs. (Im/W=light produced vs. power consumed). Clearly the use of LEDs as the lighting source in an outdoor system in addition to being more eco friendly are more efficient and less expensive to maintain than a system employing incandescent bulbs.

Accordingly, there is provided, as contemplated above, a lighting source and lighting control assembly, and fixture therefor, the combination of which to be designed so as to allow its user to comply with pertinent laws relating to wildlife preservation while maximizing the ability to obtain a determined amount and type of lighting when so desired in a more efficient and economical manner than heretofore possible.

The foregoing description of embodiments of the subject matter discussed herein is not intended to be all-inclusive. It is to be understood that various changes to the components and concepts of the description may be resorted to without departing from the spirit of the subject matter discussed herein or the scope of the claims as presented.

We claim:

1. A lighting fixture comprising:
a) a housing,
b) a lighting source being mounted within said housing and comprising a plurality of LEDs.

2. The lighting fixture as defined in claim 1 and including a lighting control system operatively connected with said lighting source, the system comprising:
a) a power converter;
b) a controller in receipt of power from the power converter, the controller adapted to command a plurality of lighting operations comprising switching between the plurality of light sources to provide selective lighting emission, motion detection for providing selective emission of light at predetermined time intervals, and coordination of networking among several light fixtures to provide selective groupings of light emissions; and
c) an alternate power source adapted for association with the controller for enabling continuity of the plurality of lighting operations.

3. A lighting fixture for outdoor use comprising:
a) a housing;
b) a lighting source being mounted within said housing and comprising a plurality of LEDs; and
c) a controller mounted within said housing and operable to command a plurality of lighting operations.

4. The lighting fixture as defined in claim 3 and said controller being operable to switch between said LEDs to provide selective lighting emission, motion detection for providing selective emission of light at predetermined time intervals, and coordination of networking among several light fixtures to provide selective groupings of light emissions.
